(19) United States
(12) Patent Application Publication
(10) Pub. No.: US 2006/0012858 A1
(43) Pub. Date: Jan. 19, 2006

(54) Microscope having a pivotable holding apparatus for optical components

(75) Inventor: Claus Bender, Werdorf (DE)

Correspondence Address: C. Paul Maliszewski, Simpson & Simpson, PLLC, 5555 Main Street, Williamsville, NY, 14221-5406, US

(73) Assignee: Leica Microsystems CMS GmbH, Wetzlar (DE)

(21) Appl. No.: 11/183,481

(22) Filed: Jul. 18, 2005

(30) Foreign Application Priority Data
Jul. 19, 2004 (DE) 10 2004 034 887.1

(51) Int. Cl. G02B 21/00; G02B 21/06

(52) U.S. Cl. 359/368; 359/390

(57) ABSTRACT

A microscope (1) having a holding apparatus, insertable reversibly into the microscope (1), for interchangeable optical components is described. According to the present invention, the holding apparatus is embodied as a pivoting drawer (10) that is arranged pivotably in and out about a pivot axis. During exchange or insertion of optical components, the pivoting drawer (10) always remains connected to the microscope stand (2) even in the pivoted-out state. It is guided while being pivoted in, so that jamming, as in the case of plug-in modules previously known from the existing art, is avoided.

### CROSS REFERENCE TO RELATED APPLICATIONS

This application claims priority of the German patent application 10 2004 034 887.1 which is incorporated by reference herein.

### FIELD OF THE INVENTION

The invention concerns a microscope having a holding apparatus, insertable reversibly into the microscope, for interchangeable optical components.

### BACKGROUND OF THE INVENTION

For specific microscopic examination methods, it is usual to provide on a microscope specific reversibly insertable holding apparatuses on which interchangeable optical components are mounted. This allows the skilled user of the microscope to optimize the microscope for his or her specific applications. It is usual, for example, for fluorescence microscopes to comprise a holding apparatus that can be pulled out on a slide, on which apparatus one or more fluorescence cubes are arranged. In addition, this holding apparatus is often arranged slidably or rotatably relative to the beam path of the microscope or its optical axis. This allows the appropriate fluorescence cube to be selected and introduced into the beam path for the particular current application.

It is also common practice for one skilled in the art, in preparation for specific applications or examinations, to remove this holding apparatus from the microscope and populate it with different fluorescence cubes. The principle of the removable holding apparatus can also be utilized in this context for other types of optical components, for example color filters, modulators (such as Hoffmann modulators), various tube lenses, etc. In microscopes that comprise a removable holding apparatus of this kind for interchangeable optical components, special requirements exist in terms of guidance of the drawer. Precise dovetail guides, for example, are usual. Difficulties nevertheless occur in practical use, since there is a danger of jamming upon insertion of the drawer. When the drawer is then taken completely out of the microscope, it is placed on the worktable by the user in order to change the optical components. The optical components can, in that context, become dusty or soiled, or damaged, or can become lost. For the case in which the drawer is to be displaceable in motorized fashion, design problems additionally exist with the placement of the motor and with energy transfer, since the drawer, after complete removal from the microscope, must be introduced again in exactly aligned fashion, and must be joined in frictionally engaged fashion to the motor and the drive system.

### SUMMARY OF THE INVENTION

It is therefore the object of the present invention to describe a microscope having a holding apparatus, insertable reversibly into the microscope, for interchangeable optical components, which microscope permits easy and reliable exchanging of optical components simultaneously with improved handling of the holding apparatus.

This object is achieved, in a microscope having a holding apparatus, insertable reversibly into the microscope, for interchangeable optical components, in that the holding apparatus is embodied as a pivoting drawer that is arranged pivotably in and out about a pivot axis.

This approach to achieving the object offers the particular advantage that the holding apparatus always remains connected to the microscope stand as optical components are exchanged or inserted; and because it is guided while being pivoted in, no special insertion conditions need to be observed. Especially in the case of an inverted microscope, in which the fluorescence device is poorly accessible, the pivoting drawer offers considerable advantages in terms of handling the fluorescence unit. The advantages of simple and precise handling along with continuously assured alignment can also be exploited when the pivoting drawer is used to retain filters, modulators, tube lenses, and other optical components.

In order to arrange the optical components on the pivoting drawer, either a laterally slidable component holder or a rotary disk, on which the optical components are retained, is arranged on the pivoting drawer. The component slider is arranged on the pivoting drawer with guidance elements in such a way that the slider is slidable relative to the drawer, and one of the optical components mounted on the slider can be selectably introduced into the beam path of the microscope. Entirely analogously, the rotary disk is installed on the pivoting drawer with a rotation shaft, in such a way that by rotation of the rotary disk, one of the optical components arranged on it can be selectably inserted into or removed from the optical beam path. One position on the component slider or rotary disk can also be unfilled, i.e. can have no optical component. This unoccupied opening can also, depending on the application, be deliberately introduced into the beam path so that the beam path is not acted upon at that point by an optical component.

Means that bring about sliding of the component slider and/or rotation of the rotary disk can be provided in the microscope, so that the selected optical component can be inserted into the beam path of the microscope. These means can encompass either mechanical components or at least one motor.

An additional advantage is obtained if detection means are provided which detect the current position of at least one optical component or all optical components on the component slider and/or on the rotary disk, or their position relative to the beam path of the microscope. This information can then be displayed to the user via a display apparatus.

In order to protect the beam path of the microscope and the optical components from dust and stray light, the pivoting drawer is preferably shaped so that with the pivoting drawer in the pivoted-in state, its outward-facing part closes off the housing surface of the microscope. In this fashion, the pivoting drawer always carries its own cover along with it as it is pivoted in and out.

To open the pivoting drawer, this outer part of the pivoting drawer that closes off the housing surface of the microscope can then be equipped with a grip recess or a handle which the microscope user can grasp in order to pivot the pivoting drawer out. It is found to be advantageous, however, if an actuation means is provided for opening the pivoting drawer. This can be, for example, a knob or a lever or an electrical button. The actuation means can moreover have associated with it a mechanical or electrical auxiliary apparatus that is activated by the actuation means and then causes the pivoting drawer to pivot out. The auxiliary apparatus can comprise, for example, a mechanical component preloaded with a spring, or an electrically controllable component that disengages a locking system of the pivoting drawer.

In a further advantageous embodiment, the pivoting drawer is actively pivoted out by a spring element after disengagement of the locking system. In order to minimize stress on the optical components and the retainers on which they are mounted, a damping element that damps the pivoting motion of the pivoting drawer can be provided on the pivoting drawer. This brings about a gentle stop at the end position when pivoting out.

### BRIEF DESCRIPTION OF THE DRAWINGS

The invention will be explained in more detail below with reference to the schematic drawings, in which:

FIG. 1 shows a microscope having a pivoting drawer for optical components that is pivoted in;

FIG. 2 shows a microscope having a pivoting drawer for optical components that is pivoted out;

FIG. 3 is a section through the central portion of the microscope, with a plan view of the pivoted-in pivoting drawer;

FIG. 4 is a section through the central portion of the microscope with the pivoting drawer pivoted out.

### DETAILED DESCRIPTION OF THE INVENTION

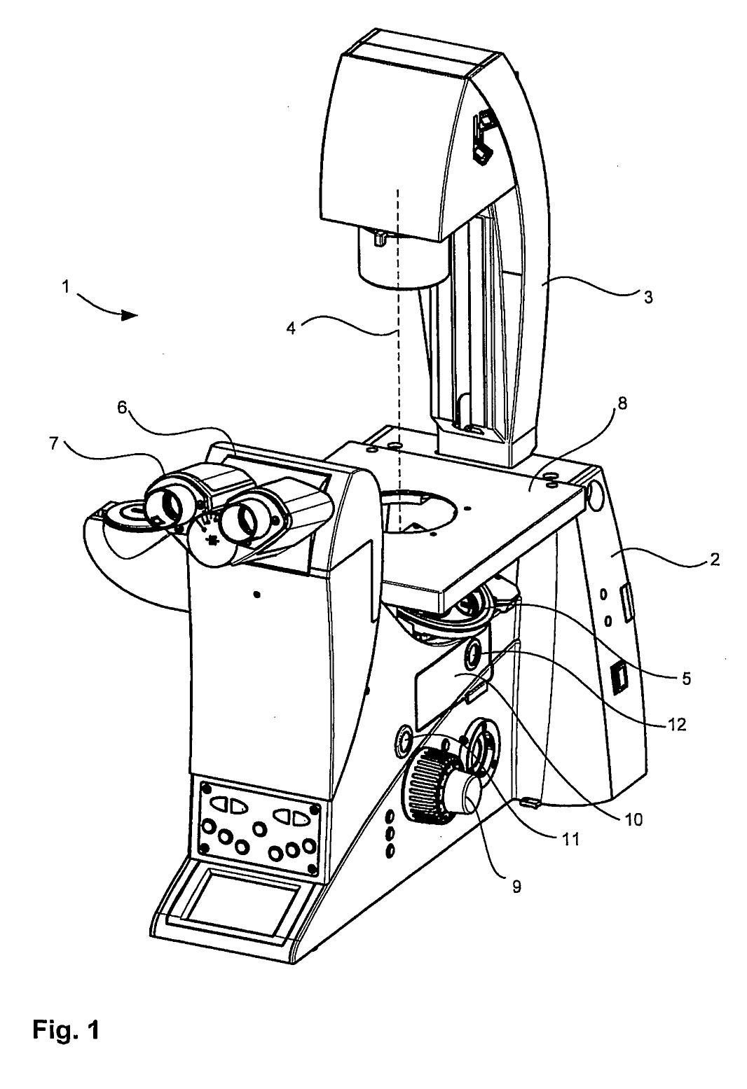

FIG. 1 shows a microscope 1 comprising a stand 2, an illumination arm 3 having an optical axis 4, and an image beam path (not depicted here) extending inside the stand. Of the components of the image beam path, objective nosepiece 5 having a microscope objective (not depicted here) positioned on the optical axis, and tube 6 with eyepieces 7, are depicted. A microscope stage 8 serves for placement of the specimens being examined. Vertical adjustment of the objective, and therefore focusing of the objective onto the specimen being examined, is performed by means of Z drive knob 9.

Provided below objective nosepiece 5 is a holding apparatus, embodied as pivoting drawer 10, for optical components. In FIG. 1 this pivoting drawer 10 is pivoted completely into stand 2. Its outer part is configured so that it makes a seal with the housing surface in such a way that neither dust nor stray light can penetrate. A pushbutton 11 serves as an actuation means for opening pivoting drawer 10. This makes it possible to use a particularly well-sealing outer surface of pivoting drawer 10, since a manual grip, e.g. in the form of grip recesses, etc., does not need to be provided. Instead, pivoting drawer 10 automatically swings out after pushbutton 11 is pressed.

As an additional aid for the user of the microscope, an inspection port 12 is provided so that correct positioning of the optical component pivoted into the beam path can be checked. For that purpose, for example, inspection port 12 can encompass at its center a diffusion panel on which the portion of interest of the beam path can be made visible.

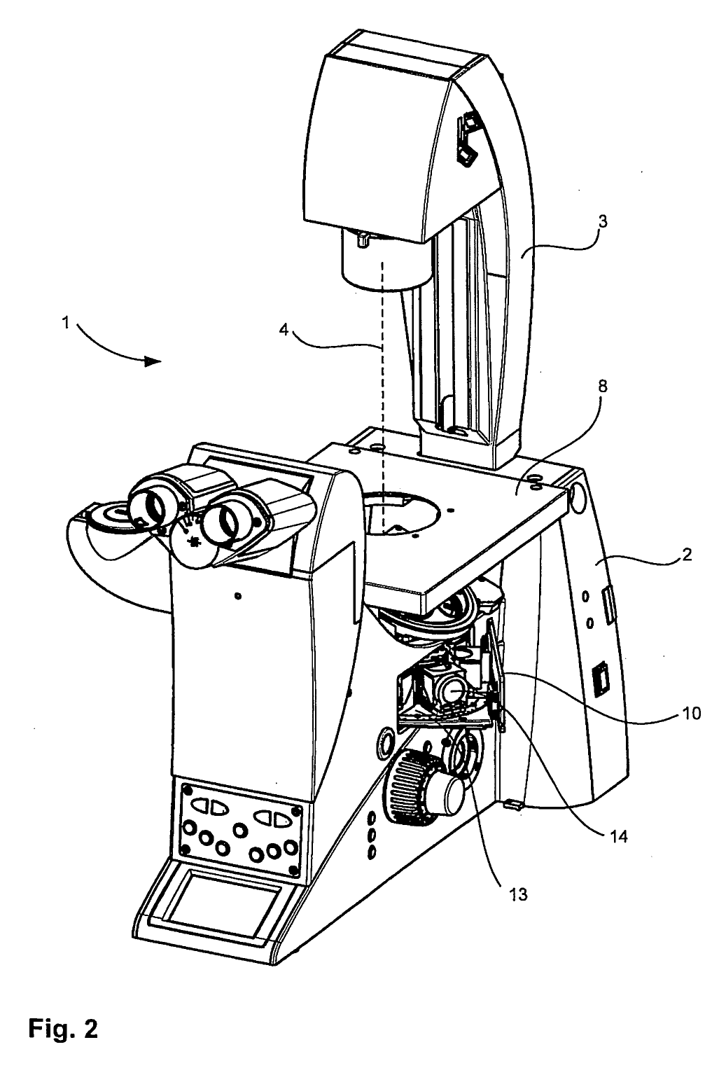

FIG. 2 shows microscope 1 with the components already described with reference to FIG. 1. Here, however, pivoting drawer 10 is pivoted out laterally about a rotation axis. Arranged on the upper side of pivoting drawer 10 is a rotary disk 13 that carries multiple fluorescence cubes 14. Details will be described further with reference to the Figures that follow.

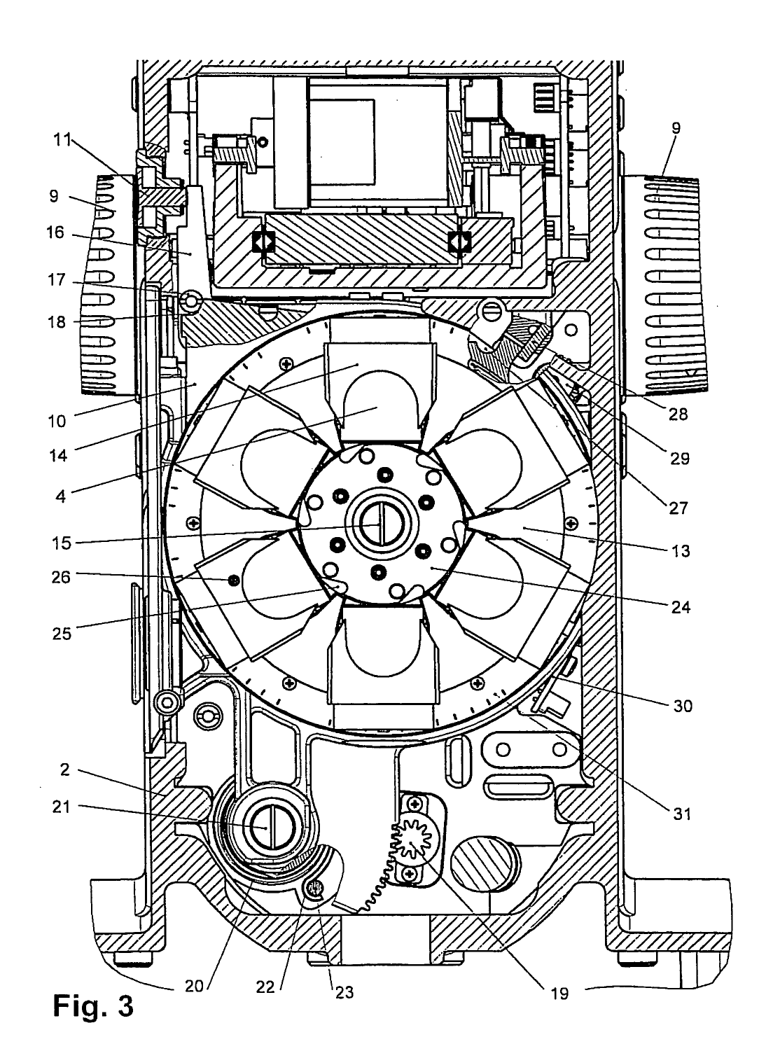

FIG. 3 is a cross section through stand 2 above Z drive knobs 9, so that pivoting drawer 10 with the optical components arranged thereon is visible. Mounted on pivoting drawer 10 is a rotary disk 13 having fluorescence cubes 14 arranged thereon. Rotary disk 13 is rotatable about a rotation shaft 15 so that a selected fluorescence cube 14 is aligned and centered on optical axis 4 in the beam path of the microscope. To open pivoting drawer 10, a pushbutton 11 is provided on stand 2. In order to open pivoting drawer 10, therefore, the latter is not itself touched by the user, but instead pushbutton 11 on stand 2 is pressed. Pushbutton 11 actuates a preloaded lever 16 whose locking peg 17 releases a countermember 18 on pivoting drawer 10. Pivoting drawer 10 then pivots out of stand 2.

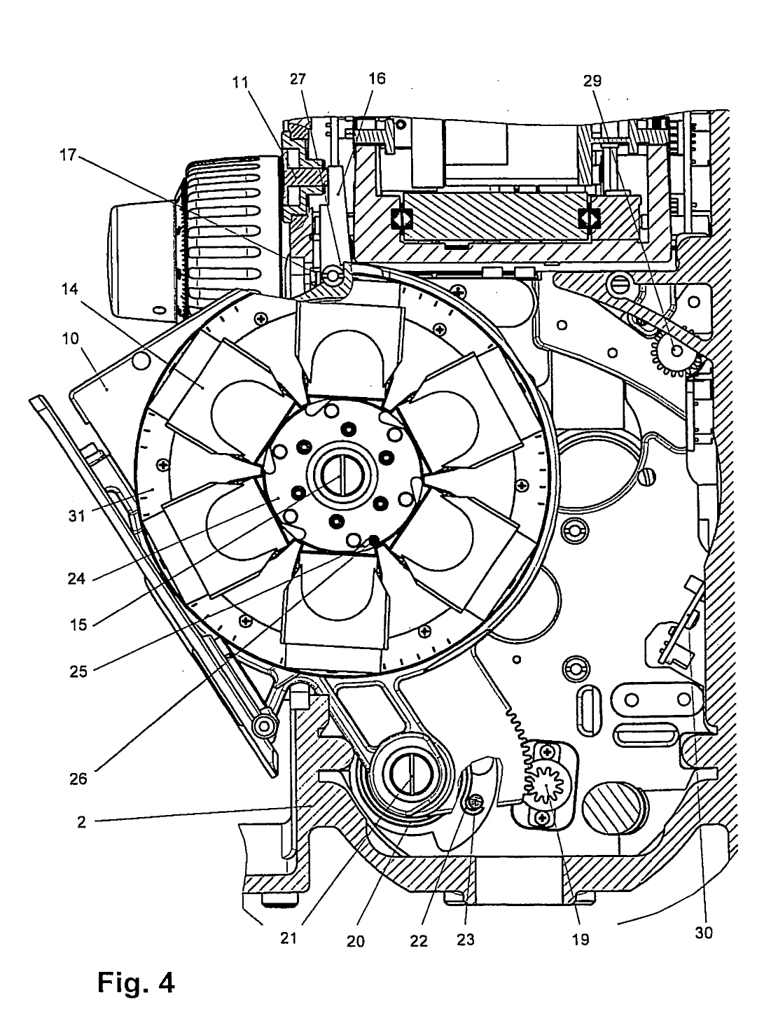

FIG. 4 presents the same view as FIG. 3, but with pivoting drawer 10 pivoted out. Identical components are labeled with identical reference numbers. To prevent pivoting drawer 10 from coming to an abrupt stop in its end position when it pivots out, and thus to prevent any possible damage to the optical components or their holding apparatuses on which they are mounted, in the advantageous embodiment shown here the pivoting-out motion is damped. For that purpose, a rotation damping element 19 is provided, which engages on the pivoting drawer and causes the pivoting drawer to swing out in a damped motion until it has reached its end position in the pivoted-out state. The energy for automatically pivoting out pivoting drawer 10 comes from a preloaded helical flat spring 20 that is arranged around pivot shaft 21 of pivoting drawer 10. A pin 23 in pivoting drawer 10 serves as the follower for spring leg 22.

To achieve optimum access to fluorescence cube 14, in an advantageous embodiment rotary disk 13 having fluorescence cube receptacles 24 is further rotated out slightly beyond the normal pivot angle of pivoting drawer 10. For that purpose, a milled groove 25 in fluorescence cube receptacle 24 fits into [sic] a pin 26 installed fixedly in stand 2, and rotates fluorescence cube receptacle 24 about rotation shaft 15 of rotary disk 13, which is also the rotation shaft for fluorescence cube receptacle 24. Rotary disk 13 is further rotated as far as a predefined stop, at which fluorescence cube 14 to be replaced is located in an optimum access position for the user. Fluorescence cubes 14 are mounted on fluorescence cube receptacles 24, for example, by way of a dovetail mount or detent mechanism that is known from the existing art.

In the pivoted-out state of rotary disk 10 [sic] as shown in FIG. 4, pivoting drawer 10 is once again locked, with locking peg 17 on lever 16, in a swing-out countermember 27 to locking peg 17. The closing of pivoting drawer 10 causes rotary disk 13 to rotate back into a detent position. Helical flat spring 20 is thereby re-cocked.

Pivoting drawer 10 is pivoted shut as far as a fixed mechanical stop 28. Once stop 28 has been reached, locking peg 17 on lever 16 once again engages into countermember 18 of pivoting drawer 10 and immobilizes it there.

In an advantageous embodiment of the invention, pivoting drawer 10 is located on a three-point support in the pivoted-in state, thereby guaranteeing optimally stable mounting and thus optimal reproducibility of the position of filter blocks 14, and thus of their optical alignment on optical axis 4. A motorized drive system for rotary disk 13 having fluorescence cubes 14 proves to be a further advantage. For this, rotary disk 13 is driven via a motor 29 having a drive pinion that, in the present exemplifying embodiment, is arranged in fixedly installed fashion in stand 2. It is also possible to arrange motor 29 on the pivoting drawer itself, although this results in a more complex voltage supply system.

Detection of the current position of fluorescence cubes 14 is accomplished via a sensor circuit board 30 that is likewise arranged in fixedly installed fashion in stand 2, and that reads an encoder disk 31 mounted on rotary disk 13.

### PARTS LIST

1 Microscope
2 Stand
3 Illumination arm
4 Optical axis
5 Objective nosepiece
6 Tube
7 Eyepiece
8 Microscope stage
9 Z drive knob
10 Pivoting drawer
11 Pushbutton
12 Inspection port
13 Rotary disk
14 Fluorescence cube
15 Rotation axis of rotary disk 13
16 Lever
17 Locking peg
18 Countermember
19 Rotation damping element
20 Helical flat spring
21 Pivot axis of rotary disk 13
22 Spring leg
23 Pin
24 Fluorescence cube receptacles
25 Groove
26 Pin
27 Swing-out countermember
28 Stop for pivoting drawer
29 Motor
30 Sensor circuit board
31 Encoder disk

What is claimed is:

1. A microscope (1) having a holding apparatus, insertable reversibly into the microscope (1), for interchangeable optical components,
wherein the holding apparatus is embodied as a pivoting drawer (10) that is arranged pivotably in and out about a pivot axis.

2. The microscope (1) as defined in claim 1, wherein the pivoting drawer (10) always remains in mechanical contact with the microscope (1) while the optical components are being changed.

3. The microscope (1) as defined in claim 1, wherein there is arranged on the pivoting drawer (10) a component slider slidable laterally with respect to the beam path, and/or a rotary disk (13), on which the optical components are retained.

4. The microscope (1) as defined in claim 3, wherein means are provided with which, by sliding of the component slider and/or rotation of the rotary disk (13), at least one optical component is insertable into the beam path of the microscope (1).

5. The microscope (1) as defined in claim 4, wherein the means encompass at least one motor.

6. The microscope (1) as defined in claim 3, wherein detection means are provided which detect the current position of at least one optical component on the component slider and/or on the rotary disk (13) and/or relative to the beam path of the microscope (1).

7. The microscope (1) as defined in claim 1, wherein the optical components are embodied as stops, fluorescence cubes (14), filters, modulators, and/or imaging or illuminating components of the beam path.

8. The microscope (1) as defined in claim 7, wherein the fluorescence cubes (14) comprise an excitation filter, a beam splitter, and a barrier filter.

9. The microscope (1) as defined in claim 1, wherein the pivoting drawer (10) is embodied so that in the pivoted-in state, it closes off the housing surface of the microscope (1).

10. The microscope (1) as defined in claim 9, wherein a grip recess and/or a handle for direct opening of the pivoting drawer (10) is arranged on the part of the pivoting drawer (10) that closes off the housing surface of the microscope (1) in the pivoted-in state.

11. The microscope (1) as defined in claim 1, wherein an actuation means for opening the pivoting drawer (10) is provided on the microscope (1) and/or on the pivoting drawer (10).

12. The microscope (1) as defined in claim 11, wherein the actuation means is a mechanical pushbutton (11) or an electrical button.

13. The microscope (1) as defined in claim 11, wherein the actuation means activates a mechanical or electrical auxiliary apparatus that causes the pivoting drawer (10) to pivot out.

14. The microscope (1) as defined in claim 13, wherein the auxiliary apparatus is a preloaded lever (16) whose locking peg (17), upon disengagement, releases a countermember (18) in the pivoting drawer (10).

15. The microscope (1) as defined in claim 1, wherein a spring element (20) that pivots the pivoting drawer (10) out is arranged on the pivoting drawer (10) and/or on the pivot shaft.

16. The microscope (1) as defined in claim 14, wherein a spring element (20) that, after release of the countermember (18) of the pivoting drawer (10), pivots the pivoting drawer (10) out is arranged on the pivoting drawer (10) and/or on the pivot shaft.

17. The microscope (1) as defined in claim 1, wherein a damping element (19) that damps the pivoting motion upon pivoting in or out is provided on the pivoting drawer (10).

18. The microscope (1) as defined in claim 1, wherein an inspection port (12), which permits a view into a portion of interest of the beam path, is provided on the pivoting drawer (10).

19. The microscope (1) as defined in claim 1, wherein the inspection port (12) encompasses a diffusion panel on which the portion of interest of the beam path can be made visible.
